(19) United States
(12) Patent Application Publication
(10) Pub. No.: US 2024/0028156 A1
(43) Pub. Date: Jan. 25, 2024

(54) DISPLAY PANEL AND DISPLAY DEVICE

(71) Applicants: Huizhou China Star Optoelectronics Display Co., Ltd., Huizhou, Guangdong (CN); TCL Chaina Star Optoelectronics Technology Co., Ltd., Shenzhen, Guangming New District (CN)

(72) Inventor: Aimin DAI, Huizhou, Guangdong (CN)

(73) Assignees: Huizhou China Star Optoelectronics Display Co., Ltd., Huizhou, Guangdong (CN); TCL China Star Optoelectronics Technology Co., Ltd., Shenzhen, Guangdong (CN)

(21) Appl. No.: 17/418,909

(22) PCT Filed: May 31, 2021
(86) PCT No.: PCT/CN2021/097329

§ 371 Date: Nov. 3, 2022

(30) Foreign Application Priority Data
Apr. 25, 2021 (CN) 202110449438.8

(51) Int. Cl. G06F 3/041

(52) U.S. Cl. CPC G06F 3/04166; G06F 3/0412; G06F 3/0446

(57) ABSTRACT

A display panel and a display device are disclosed. The display panel includes a plurality of display areas, each of the display areas is independently provided with a sensing module configured to sense electrical signals in one of the display areas corresponding to the sensing module. The display panel further includes a plurality of control modules and a master control unit, each sensing module is correspondingly connected to one of the control modules, and each of the control modules is configured to converge the electrical signals sensed by each sensing module to the master control unit.

### FIELD OF INVENTION

The present disclosure relates to the field of display technologies, and more particularly, to a display panel and a display device.

### BACKGROUND OF INVENTION

With development of display screens, sizes thereof are getting larger and larger. However, with an increase of the sizes of the display screens, requirements for a number of channels and driving abilities of integrated circuits are getting higher. For large-sized display devices, the number of channels of conventional driving architectures are significantly insufficient, thereby causing functions of the display devices to be poorer. Taking capacitive touch control display screens as an example, the capacitive touch control display screens have advantages of pure flat planes, narrow bezels, strong resistances to dust and oil stains, and low power consumption, so they are gradually replacing infrared touch control display screens to become a mainstream trend in markets. However, with an increase of sizes of touch control display screens, the number of channels of the conventional driving architectures are significantly insufficient, thereby causing touch control accuracy of the touch control display screens to be poorer.

Technical problem: the present disclosure provides a display panel and a display device to solve a technical problem of poorer functions caused by an insufficient number of channels in driving architectures of conventional display panels.

### SUMMARY OF INVENTION

To solve the above problem, an embodiment of the present disclosure provides following technical solutions:
a display panel includes a plurality of display areas, and each of the display areas is independently provided with a sensing module configured to sense electrical signals in one of the display areas corresponding to the sensing module; and the display panel further includes a plurality of control modules and a master control unit, each sensing module is correspondingly connected to one of the control modules, and each of the control modules is configured to converge the electrical signals sensed by each sensing module to the master control unit.

Further, each of the control modules includes a lower level micro control unit, the master control unit includes an upper level micro control unit, and each lower level micro control unit is connected to the upper level micro control unit to converge the electrical signals sensed by each sensing module to the master control unit.

Further, each of the display areas is provided with a first channel and a second channel, respectively, and the first channel and the second channel are configured to establish line connections between one of the display areas and one of the control modules corresponding to the one of the display areas.

Further, each of the display areas includes a first side and a second side adjacent to each other, and the first side and the second side coincide with outer sides of the display panel; and the first side is provided with a group of first signal lines, the second side is provided with a group of second signal lines, the first signal lines are configured to connect driving electrode blocks corresponding to the one of the display areas to the first channel, and the second signal lines are configured to connect sensing electrode blocks corresponding to the one of the display areas to the second channel.

Further, the display panel includes four display areas arranged in a four-square configuration; and the first side of the one of the display areas and the first side of one adjacent display area together constitute a first outer side of the display panel, the second side of the one of the display areas and the second side of another adjacent display area together constitute a second outer side of the display panel, and the first outer side is adjacent to the second outer side.

Further, the display panel further includes driving layers and sensing layers disposed on the driving layers, the driving layers in different display areas are independent of each other, and the sensing layers in different display areas are independent of each other.

Further, the driving layers and/or the sensing layers include a substrate layer and a functional layer, and the functional layer is disposed on single side or both sides of the substrate layer.

Further, the substrate layer uses a transparent material, and the transparent material is an insulating film or glass.

Further, the display panel further includes a display layer, the driving layers are disposed on the display layer, and the sensing layers are disposed on one side of the driving layers facing away from the display layer.

The present disclosure further provides a display device, which

includes a display panel. Wherein, the display panel includes a plurality of display areas, each of the display areas is independently provided with a sensing module configured to sense electrical signals in one of the display areas corresponding to the sensing module; and the display panel further includes a plurality of control modules and a master control unit, each sensing module is correspondingly connected to one of the control modules, and each of the control modules is configured to converge the electrical signals sensed by each sensing module to the master control unit.

Further, each of the control modules includes a lower level micro control unit, the master control unit includes an upper level micro control unit, and each lower level micro control unit is connected to the upper level micro control unit to converge the electrical signals sensed by each sensing module to the master control unit.

Further, each of the display areas is provided with a first channel and a second channel, respectively, and the first channel and the second channel are configured to establish line connections between one of the display areas and one of the control modules corresponding to the one of the display areas.

Further, each of the display areas includes a first side and a second side adjacent to each other, and the first side and the second side coincide with outer sides of the display panel; and the first side is provided with a group of first signal lines, the second side is provided with a group of second signal lines, the first signal lines are configured to connect driving electrode blocks corresponding to the one of the display areas to the first channel, and the second signal lines are configured to connect sensing electrode blocks corresponding to the one of the display areas to the second channel.

Further, the display panel includes four display areas arranged in a four-square configuration; and the first side of the one of the display areas and the first side of one adjacent display area together constitute a first outer side of the display panel, the second side of the one of the display areas and the second side of another adjacent display area together constitute a second outer side of the display panel, and the first outer side is adjacent to the second outer side.

Further, the display panel further includes driving layers and sensing layers disposed on the driving layers, the driving layers in different display areas are independent of each other, and the sensing layers in different display areas are independent of each other.

Further, the driving layers and/or the sensing layers include a substrate layer and a functional layer, and the functional layer is disposed on single side or both sides of the substrate layer.

Further, the substrate layer uses a transparent material, and the transparent material is an insulating film or glass.

Further, the display panel further includes a display layer, the driving layers are disposed on the display layer, and the sensing layers are disposed on one side of the driving layers facing away from the display layer.

Further, the display device further includes a motherboard, wherein, the master control unit is connected to the motherboard to transmit converged electrical signals to the motherboard.

Beneficial effect: beneficial effects of the present disclosure are that in the display panel and the display device provided by the present disclosure, the display panel is divided into the plurality of display areas, and each of the display areas is independently provided with the sensing module corresponding thereto. The present disclosure can effectively increase a number of channels of a driving architecture of the display panel by each sensing module independently identifying the electrical signals in corresponding display areas, then each of the control modules converging identified electrical signals to the master control unit, and then the master control unit uniformly coordinating and controlling the identified electrical signals. Therefore, a technical problem of poorer functions caused by an insufficient number of channels of driving architectures in large-sized display panels of current technology can be solved.

### DESCRIPTION OF DRAWINGS

The accompanying figures to be used in the description of embodiments of the present disclosure will be described in brief to more clearly illustrate the technical solutions of the embodiments. The accompanying figures described below are only a part of the embodiments of the present disclosure, from which those skilled in the art can derive further figures without making any inventive efforts.

FIG. 1 is a schematic structural diagram of a display device and a display panel according to an embodiment of the present disclosure.

FIG. 2 is a schematic planar diagram of the display panel shown in FIG. 1.

FIG. 3 is a schematic stacked structural diagram of a touch control display panel according to an embodiment of the present disclosure.

FIG. 4 is a schematic stacked structural diagram of a driving layer and/or a sensing layer of the touch control display panel according to an embodiment of the present disclosure.

FIG. 5 is another schematic stacked structural diagram of the driving layer and/or the sensing layer of the touch control display panel according to an embodiment of the present disclosure.

FIG. 6 is a schematic planar diagram of the touch control display panel according to an embodiment of the present disclosure.

FIG. 7 is another schematic planar diagram of the touch control display panel according to an embodiment of the present disclosure.

FIG. 8 is a schematic structural block diagram of the touch control display panel according to an embodiment of the present disclosure.

FIG. 9 is a schematic planar diagram of a touch control structure of the touch control display panel according to an embodiment of the present disclosure.

FIG. 10 is a schematic driving architectural diagram of the touch control display panel according to an embodiment of the present disclosure.

### DETAILED DESCRIPTION OF PREFERRED EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative efforts are within the scope of the present disclosure. In addition, it should be understood that the specific embodiments described herein are only used to illustrate and explain the present disclosure and are not used to limit the present disclosure. In the present disclosure, in the case of no explanation to the contrary, the orientation words used such as “on” and “under” usually refer to upper and lower directions of the device in actual use or working state, specifically the directions in the drawings, and “inside” and “outside” refer to the outline of the device. The present disclosure provides a display device and a display panel.

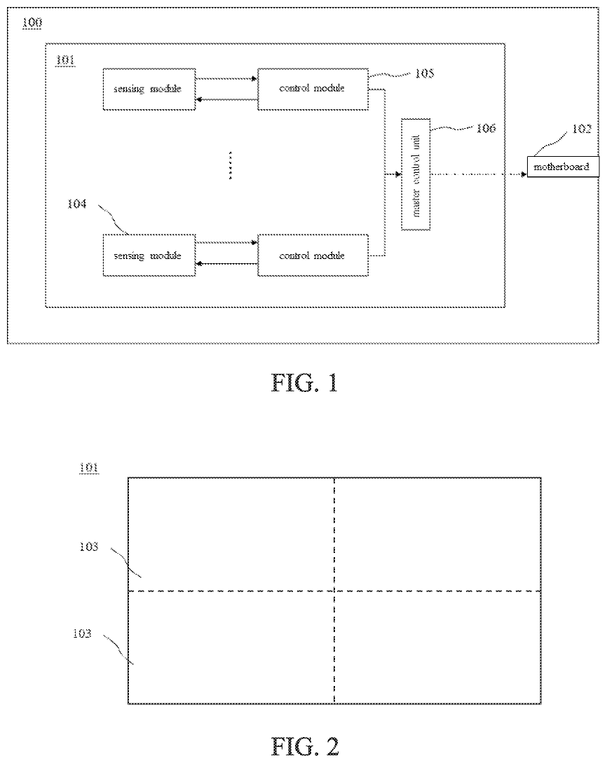

FIG. 1 is a schematic structural diagram of the display device and the display panel according to an embodiment of the present disclosure, and FIG. 2 is a schematic planar diagram of the display panel. Referring to FIGS. 1 and 2, the display device 100 includes the display panel 101 and a motherboard 102. The display panel 101 includes a plurality of display areas 103, and each of the display areas 103 is independently provided with a sensing module 104 configured to sense electrical signals in one of the display areas 103 corresponding to the sensing module 104. The display panel 101 further includes a plurality of control modules 105 and a master control unit 106, each sensing module 104 is connected to one of the control modules 105 corresponding thereto, and each of the control modules 105 is configured to converge the electrical signals sensed by each sensing module 104 to the master control unit 106. The master control unit 106 is connected to the motherboard 102 at a same time to transmit converged electrical signals to the motherboard 102, thereby using a motherboard system of the motherboard 102 to process the converged electrical signals.

The display panel 101 uses a whole panel, division of the display areas 103 is virtual, and each of the display areas 103 independently uses the sensing module 104 and the one of the control modules 105 to connect with the master control unit 106. That is, a driving architecture of entire display panel is formed by splicing independent driving architectures in different display areas. Wherein, the electrical signals may be touch control signals, light-sensitive sensing signals, etc., and correspondingly, the sensing module 104 may be a touch control sensing module, a light-sensitive sensing module, etc. The master control unit 106 may connect to the motherboard 102 by universal serial bus (USB), but is not limited to this.

In the display panel 101 and the display device 100 provided by the present disclosure, the display panel 101 is divided into the plurality of display areas 103, and each of the display areas 103 is independently provided with the sensing module 104 corresponding thereto. The present disclosure can effectively increase a number of channels of the driving architecture of the display panel 101 by each sensing module 104 independently identifying the electrical signals in corresponding display areas 103, then each of the control modules 105 converging identified electrical signals to the master control unit 106, and then the master control unit 106 uniformly coordinating and controlling the identified electrical signals. Therefore, a technical problem of poorer functions caused by an insufficient number of channels of driving architectures in large-sized display panels of current technology can be solved.

The following takes a touch control display panel and a touch control display device as a specific example for detailed descriptions.

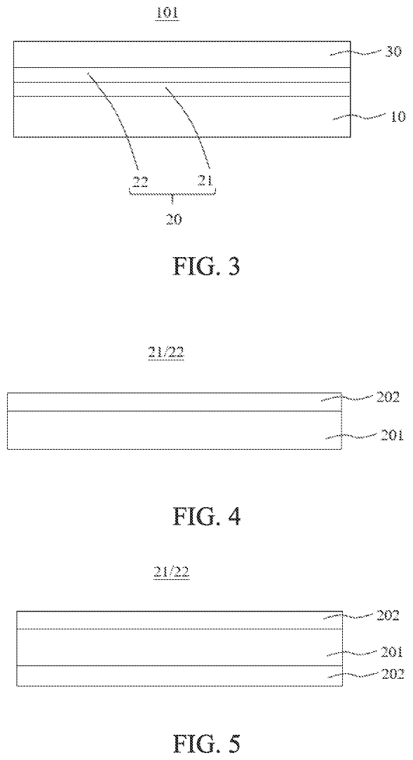

Referring to FIG. 3, the display panel 101 provided in this embodiment of the present disclosure is the touch control display panel, which includes a display layer 10, a touch control layer 20, and a coverplate 30. The display layer 10 is configured to display pictures, the touch control layer 20 is disposed on the display layer 10, and the coverplate 30 is disposed on the touch control layer 20 for protecting the touch control layer 20. In this embodiment, the display layer 10 uses a liquid crystal display structure. It can be understood that in other embodiments, the display layer 10 may also use other display structures according to practical situations.

The touch control layer 20 includes driving layers 21 and sensing layers 22 disposed on the driving layers 21. The driving layers 21 are disposed on the display layer 10, and the sensing layers 22 are disposed on the driving layers 21. The driving layers 21 and the sensing layers 22 are insulated from each other to form mutual capacitive touch control stacked structures.

Specifically, the driving layers 21 and/or the sensing layers 22 include a substrate layer 201 and a functional layer 202, and the functional layer 202 is disposed on single side or both sides of the substrate layer 201, which are shown in FIGS. 4 and 5, respectively. The substrate layer 201 is manufactured by a transparent material, which may be selected from an insulating film or glass, but is not limited to this.

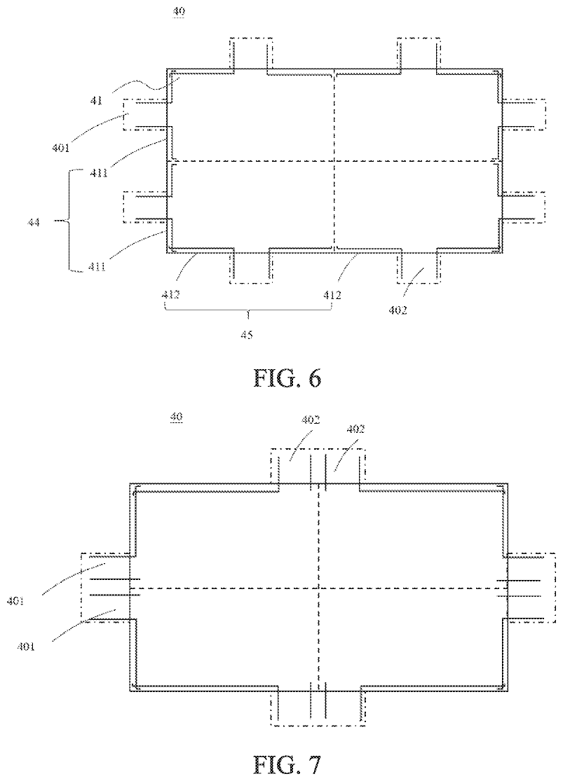

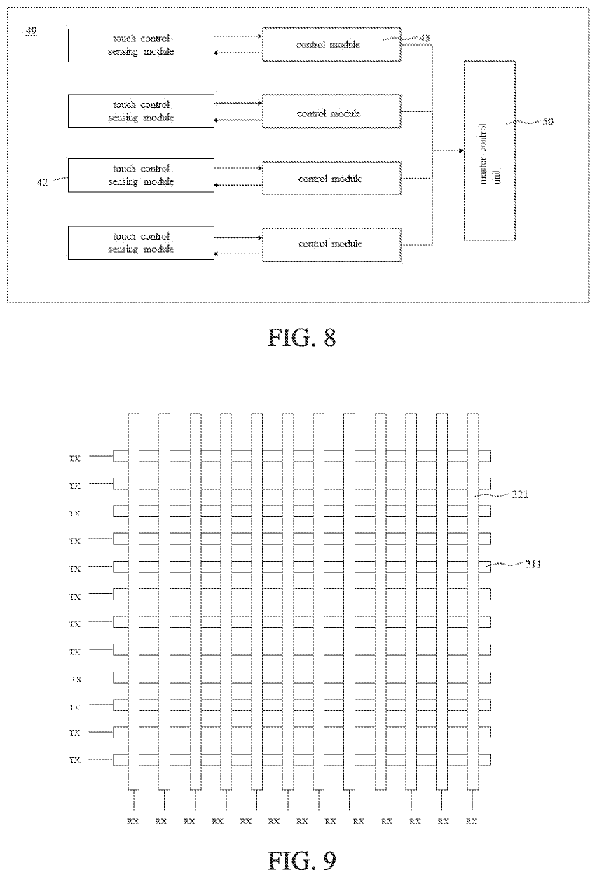

Referring to FIG. 6, the touch control layer 20 forms a touch control display area 40, the touch control display area 40 is virtually divided into a plurality of touch control areas 41, and each of the touch control areas 41 corresponds to one of the display areas 103 of the display panel 101. Referring to FIG. 8 at a same time, each of the touch control areas 41 is independently provided with a touch control sensing module 42, and the touch control sensing module 42 is a specific example of the sensing module 104 of the display panel 101. The touch control sensing module 42 is configured to sense touch control signals in one of the touch control areas 41 corresponding thereto, and the touch control signals are one of specific examples of the electrical signals mentioned above. The touch control display area 40 also includes a plurality of control modules 43 and a master control unit 50, and the control modules 43 and the master control unit 50 correspond to the control modules 105 and the master control unit 106 mentioned above, respectively. Each touch control sensing module 42 is connected to one of the control modules 43 corresponding thereto, and each of the control modules 43 is configured to converge the touch control signals sensed by each touch control sensing module 42 to the master control unit 50.

Specifically, the driving layers 21 in different touch control areas 41 are independent of each other, and the sensing layers 22 in different touch control areas 41 are independent of each other. Referring to FIG. 9, in each of the touch control areas 41, one of the driving layers 21 includes a plurality of driving electrode blocks 211 arranged at intervals in a first direction, and one of the sensing layers 22 includes a plurality of sensing electrode blocks 221 arranged at intervals in a second direction. The driving electrode blocks 211 and the sensing electrode blocks 221 are arranged crosswise and constitute the touch control sensing module 42 corresponding thereto.

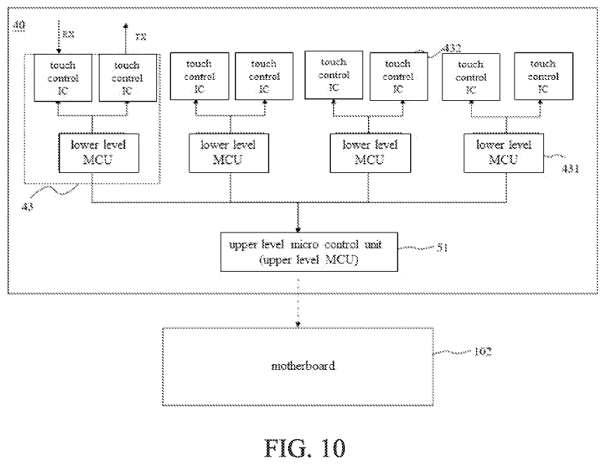

Referring to FIG. 6 again, each of the touch control areas 41 is provided with a first channel 401 and a second channel 402, respectively. The first channel 401 and the second channel 402 are configured to establish line connections between one of the touch control areas 41 and one of the control modules 43 corresponding thereto, as shown in FIG. 10.

Referring to FIGS. 6 and 9 at a same time, each of the touch control areas 41 includes a first side 411 and a second side 412 adjacent to each other. The first side 411 and the second side 412 coincide with outer sides of the touch control display area 40. The first side 411 is provided with a group of first signal lines (TX), and the second side 412 is provided with a group of second signal lines (RX). The first signal lines (TX) are configured to connect the driving electrode blocks 211 corresponding to the one of the touch control areas 41 to the first channel 401, and the second signal lines (RX) are configured to connect the sensing electrode blocks 221 corresponding to the one of the touch control areas 41 to the second channel 402.

First channels 401/second channels 402 in adjacent touch control areas 41 are arranged side by side. In this embodiment, the first channels 401/the second channels 402 in the adjacent touch control areas 41 are arranged side by side at intervals, as shown in FIG. 6. It can be understood that the first channels 401/the second channels 402 in the adjacent touch control areas 41 may also be arranged side by side without intervals, as shown in FIG. 7.

In this embodiment, the touch control display area 40 is divided into four touch control areas 41 that are independent of each other. The four touch control areas 41 are arranged in a four-square configuration. The first side 411 of the one of the touch control areas 41 and the first side 411 of one adjacent touch control area 41 together constitute a first outer side 44 of the touch control display area 40, that is, a first outer side of the display panel 101. The second side 412 of the one of the touch control areas 41 and the second side 412 of another adjacent touch control area 41 together constitute a second outer side 45 of the touch control display area 40, that is, a second outer side of the display panel 101, and the first outer side 44 is adjacent to the second outer side 45. In such setting, each of the touch control areas is driven by dual drive method, thereby effectively improving driving abilities of the display device 100. It can be understood that in other embodiments, the touch control display area may also be divided into other number of touch control areas 41 and is not limited to four.

Referring to FIG. 10, each of the control modules 43 includes a lower level micro control unit 431, and the master control unit 50 includes an upper level micro control unit 51. Each lower level micro control unit 431 is connected to the upper level micro control unit 51 to converge the touch control signals sensed by each touch control sensing module 42 to the master control unit 50.

Specifically, in this embodiment, each of the control modules 43 further includes two touch control integrated circuits (touch control ICs) 432. Each of the touch control ICs 432 is connected to the lower level micro control unit 431, respectively. It can be understood that in other embodiments, the control modules 43 may also use other structures, such as four touch control ICs 432 or the touch control ICs 432 and the lower level micro control unit 431 being integrated.

Compared to current technology, in the touch control display panel and the touch control display device of the present disclosure, the touch control display area 40 is divided into the plurality of touch control areas 41, and each of the touch control areas 41 is independently provided with the touch control sensing module 42. The present disclosure can effectively increase a number of channels of a driving architecture of the touch control display panel by each touch control sensing module 42 independently identifying the touch control signals in corresponding touch control areas 41, then each of the control modules 43 converging identified touch control signals to the master control unit 50, and then the master control unit 50 uniformly coordinating and controlling the identified touch control signals. Therefore, touch control accuracy of the touch control display device can be improved.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

1. A display panel, comprising a plurality of display areas, wherein each of the display areas is independently provided with a sensing module configured to sense electrical signals in one of the display areas corresponding to the sensing module; and
the display panel further comprises a plurality of control modules and a master control unit, each sensing module is correspondingly connected to one of the control modules, and each of the control modules is configured to converge the electrical signals sensed by each sensing module to the master control unit.

2. The display panel according to claim 1, wherein each of the control modules comprises a lower level micro control unit, the master control unit comprises an upper level micro control unit, and each lower level micro control unit is connected to the upper level micro control unit to converge the electrical signals sensed by each sensing module to the master control unit.

3. The display panel according to claim 1, wherein each of the display areas is provided with a first channel and a second channel, respectively, and the first channel and the second channel are configured to establish line connections between one of the display areas and one of the control modules corresponding to the one of the display areas.

4. The display panel according to claim 3, further comprising driving layers and sensing layers disposed on the driving layers, wherein the driving layers and the sensing layers correspond to the display areas by one to one, each of the driving layers comprises a plurality of driving electrode blocks, and each of the sensing layers comprises a plurality of sensing electrode blocks;
wherein each of the display areas comprises a first side and a second side adjacent to each other, and the first side and the second side coincide with outer sides of the display panel; and
the first side is provided with a group of first signal lines, the second side is provided with a group of second signal lines, the first signal lines are configured to connect the driving electrode blocks corresponding to the one of the display areas to the first channel, and the second signal lines are configured to connect the sensing electrode blocks corresponding to the one of the display areas to the second channel.

5. The display panel according to claim 4, comprising four display areas arranged in a four-square configuration;
wherein the first side of the one of the display areas and the first side of one adjacent display area together constitute a first outer side of the display panel, the second side of the one of the display areas and the second side of another adjacent display area together constitute a second outer side of the display panel, and the first outer side is adjacent to the second outer side.

6. The display panel according to claim 4, wherein the driving layers in different display areas are independent of each other, and the sensing layers in different display areas are independent of each other.

7. The display panel according to claim 6, wherein the driving layers or the sensing layers comprise a substrate layer and a functional layer, and the functional layer is disposed on single side or both sides of the substrate layer.

8. The display panel according to claim 7, wherein the substrate layer uses a transparent material, and the transparent material is an insulating film or glass.

9. The display panel according to claim 6, further comprising a display layer, wherein the driving layers are disposed on the display layer, and the sensing layers are disposed on one side of the driving layers facing away from the display layer.

10. A display device, comprising a display panel, wherein the display panel comprises a plurality of display areas, each of the display areas is independently provided with a sensing module configured to sense electrical signals in one of the display areas corresponding to the sensing module; and
the display panel further comprises a plurality of control modules and a master control unit, each sensing module is correspondingly connected to one of the control modules, and each of the control modules is configured to converge the electrical signals sensed by each sensing module to the master control unit.

11. The display device according to claim 10, wherein each of the control modules comprises a lower level micro control unit, the master control unit comprises an upper level micro control unit, and each lower level micro control unit is connected to the upper level micro control unit to converge the electrical signals sensed by each sensing module to the master control unit.

12. The display device according to claim 10, wherein each of the display areas is provided with a first channel and a second channel, respectively, and the first channel and the second channel are configured to establish line connections between one of the display areas and one of the control modules corresponding to the one of the display areas.

13. The display device according to claim 12, wherein the display panel further comprises driving layers and sensing layers disposed on the driving layers, the driving layers and the sensing layers correspond to the display areas by one to one, each of the driving layers comprises a plurality of driving electrode blocks, and each of the sensing layers comprises a plurality of sensing electrode blocks;
wherein each of the display areas comprises a first side and a second side adjacent to each other, and the first side and the second side coincide with outer sides of the display panel; and
the first side is provided with a group of first signal lines, the second side is provided with a group of second signal lines, the first signal lines are configured to connect the driving electrode blocks corresponding to the one of the display areas to the first channel, and the second signal lines are configured to connect the sensing electrode blocks corresponding to the one of the display areas to the second channel.

14. The display device according to claim 13, wherein the display panel comprises four display areas arranged in a four-square configuration; and
the first side of the one of the display areas and the first side of one adjacent display area together constitute a first outer side of the display panel, the second side of the one of the display areas and the second side of another adjacent display area together constitute a second outer side of the display panel, and the first outer side is adjacent to the second outer side.

15. The display device according to claim 13, wherein the driving layers in different display areas are independent of each other, and the sensing layers in different display areas are independent of each other.

16. The display device according to claim 15, wherein the driving layers or the sensing layers comprise a substrate layer and a functional layer, and the functional layer is disposed on single side or both sides of the substrate layer.

17. The display device according to claim 16, wherein the substrate layer uses a transparent material, and the transparent material is an insulating film or glass.

18. The display device according to claim 15, wherein the display panel further comprises a display layer, the driving layers are disposed on the display layer, and the sensing layers are disposed on one side of the driving layers facing away from the display layer.

19. The display device according to claim 10, further comprising a motherboard, wherein the master control unit is connected to the motherboard to transmit converged electrical signals to the motherboard.
